(19) United States
(12) Patent Application Publication
(10) Pub. No.: US 2022/0129694 A1
(43) Pub. Date: Apr. 28, 2022

(54) ELECTRONIC DEVICE AND METHOD FOR SCREENING SAMPLE

(71) Applicant: Coretronic Corporation, Hsin-Chu (TW)

(72) Inventors: Yi-Fan Liou, Hsin-Chu (TW); Hsin-Ya Liang, Hsin-Chu (TW); Kai-Cheng Hu, Hsin-Chu (TW)

(73) Assignee: Coretronic Corporation, Hsin-Chu (TW)

(21) Appl. No.: 17/499,884

(22) Filed: Oct. 13, 2021

(30) Foreign Application Priority Data
Oct. 26, 2020 (TW) 109137056

(51) Int. Cl. G06K 9/62; G06F 17/16; G06N 3/02

(52) U.S. Cl. CPC G06K 9/6215; G06N 3/02; G06F 17/16

(57) ABSTRACT

An electronic device and a method for screening a sample are provided. The method includes the following steps. N samples corresponding to a first object are received, in which the N samples include a first sample. N similarity vectors respectively corresponding to the N samples are calculated, in which the N similarity vectors include a first similarity vector corresponding to the first sample. The first similarity vector includes multiple first similarities between the first sample and each of the N samples except the first sample. The first sample is determined to be a representative sample of the first object in response to an average value of the first similarities of the first similarity vector being the maximum value among average values of N similarities respectively corresponding to the N similarity vectors.

### CROSS-REFERENCE TO RELATED APPLICATION

This application claims the priority benefit of Taiwan application serial no. 109137056, filed on Oct. 26, 2020. The entirety of the above-mentioned patent application is hereby incorporated by reference herein and made a part of this specification.

### BACKGROUND

### Technical Field

This disclosure relates to an electronic device and a method, and in particular to an electronic device and a method for screening a sample.

### Description of Related Art

With the development of artificial intelligence, more and more industries have begun to apply neural network technology to improve products or their related processes. The efficacy of neural networks has to be improved through learning. In general, a neural network that is trained by more training data will have a better efficacy. However, too much training data may cause a delay in the training process of the neural network. On the other hand, when a sample in the training data is subjected to noise interference, the efficacy of the neural network trained through these training data would also be reduced due to the influence of the noise interference. Therefore, how to provide a method for screening a training sample is one of great importance to those skilled in the art.

The information disclosed in this background section is only for enhancement of understanding of the background of the described technology, and therefore it may contain information that does not form the prior art that is already known to a person of ordinary skill in the art. Furthermore, the information disclosed in the background section does not mean that one or more problems to be resolved by one or more embodiments of the disclosure were acknowledged by a person of ordinary skill in the art.

### SUMMARY

This disclosure provides an electronic device and a method for screening a sample, which can select a most representative sample from numerous samples so as to remove noise interference or reduce the amount of data.

An electronic device for screening a sample of the disclosure includes a transceiver, a storage media, and a processor. The storage media stores multiple modules. The processor is coupled to the storage media and the transceiver, and accesses and executes the multiple modules. The multiple modules include a sample collection module and a sample screening module. The sample collection module receives N samples corresponding to a first object through the transceiver. The N samples include a first sample. The sample screening module calculates N similarity vectors respectively corresponding to the N samples. The N similarity vectors contain a first similarity vector corresponding to the first sample. The first similarity vector includes multiple first similarities between the first sample and each of the N samples except the first sample. The first sample is determined to be a representative sample of the first object by the sample screening module in response to an average value of the first similarities of the first similarity vector being the maximum value among average values of N similarities respectively corresponding to the N similarity vectors.

In an embodiment of the disclosure, the sample screening module calculates elements in each of the N similarity vectors according to at least one of an inner product, an Euclidean distance, a Manhattan distance, and a Chebyshev distance.

In an embodiment of the disclosure, the N samples include a false positive sample of the first object.

In an embodiment of the disclosure, the sample screening module calculates a similarity matrix of the N samples to obtain the N similarity vectors.

In an embodiment of the disclosure, the N samples further include a second sample. The N similarity vectors further include a second similarity vector corresponding to the second sample. The second sample is filtered out from the N samples by the sample screening module in response to an average value of second similarities of the second similarity vector being the minimum value among average values of the N similarities.

In an embodiment of the disclosure, the sample collection module receives a newly added sample corresponding to the first object through the transceiver. The sample screening module calculates a newly added sample similarity vector corresponding to the newly added sample. The newly added sample similarity vector includes multiple similarities between the newly added sample and each of the N samples. The sample screening module adds the newly added sample to the N samples in response to an average value of the similarities of the newly added sample similarity vector being greater than an average value of the average values of the N similarities; and deletes the newly added sample in response to the average value of the similarities of the newly added sample similarity vector being less than the average value of the average values of the N similarities.

A method for screening a sample of the disclosure includes the following steps. N samples corresponding to a first object are received. The N samples include a first sample. N similarity vectors corresponding to the N samples are calculated. The N similarity vectors include a first similarity vector corresponding to the first sample. The first similarity vector includes multiple first similarities between the first sample and each of the N samples except the first sample. The first sample is determined to be a representative sample of the first object in response to an average value of the first similarities of the first similarity vector being the maximum value among average values of N similarities respectively corresponding to the N similarity vectors.

In an embodiment of the disclosure, the step of calculating the N similarity vectors respectively corresponding to the N samples includes calculating elements in each of the N similarity vectors according to at least one of an inner product, an Euclidean distance, a Manhattan distance, and a Chebyshev distance.

In an embodiment of the disclosure, the N samples include a false positive sample of the first object.

In an embodiment of the disclosure, the step of calculating the N similarity vectors respectively corresponding to the N samples respectively includes calculating a similarity matrix of the N samples to obtain the N similarity vectors.

In an embodiment of the disclosure, the N samples further include a second sample. The N similarity vectors further include a second similarity vector corresponding to the second sample. The method further includes filtering out the second sample from the N samples in response to an average value of second similarities of the second similarity vector being the minimum value among the average values of the N similarities.

In an embodiment of the disclosure, the method further includes the following steps. A newly added sample corresponding to the first object is received. A newly added sample similarity vector corresponding to the newly added sample is calculated. The newly added sample similarity vector includes multiple similarities between the newly added sample and each of the N samples. The newly added sample is added to the N samples in response to an average value of the similarities of the newly added sample similarity vector being greater than an average value of the average values of the N similarities. The newly added sample is deleted in response to the average value of the similarities of the newly added sample similarity vector being less than the average value of the average values of the N similarities.

Based on the above, the disclosure provides the electronic device and the method for screening a sample, which can select a representative sample that best represents the multiple samples from the multiple samples. In addition, if there is an erroneous sample (or a sample that is subjected to severe noise interference) in the multiple samples, the disclosure can also filter out the erroneous sample, enabling the efficacy of the trained neural network to not be reduced due to the influence of the erroneous sample.

Other objectives, features and advantages of the disclosure can be further understood from the further technological features disclosed by the embodiments of the disclosure in which there are shown and described as exemplary embodiments of the disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and together with the descriptions serve to explain the principles of the disclosure.

FIG. 1 shows a schematic diagram of an electronic device for screening a sample according to an embodiment of the disclosure.

FIG. 2 is a schematic diagram of a similarity matrix between N images and average values of similarities corresponding to each of the N images according to an embodiment of the disclosure

FIG. 3 shows a flowchart of a method for screening a sample according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings.

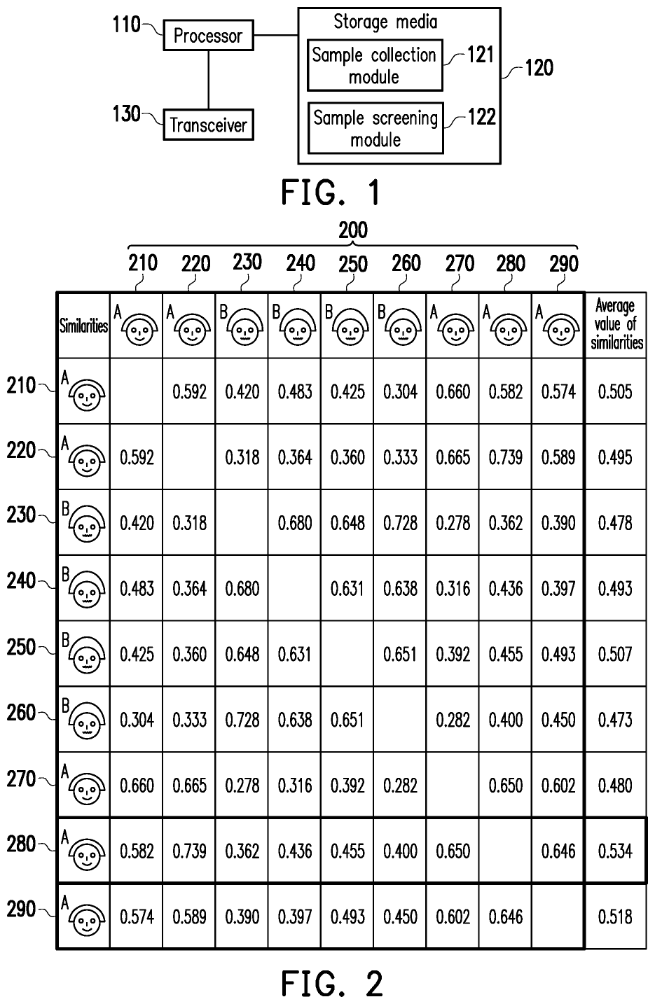

FIG. 1 shows a schematic diagram of an electronic device 100 for screening a sample according to an embodiment of the disclosure. The electronic device 100 may include a processor 110, a storage media 120, and a transceiver 130.

The processor 110 is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar elements, or a combination of the above elements. The processor 110 may be coupled to the storage media 120 and the transceiver 130, and accesses and executes multiple modules, or other types of applications stored in the storage media 120.

The storage media 120 is, for example, any type of fixed or removable random access memory (RAM), a read-only memory (ROM), a flash memory, a hard disk drive (HDD), a solid-state drive (SSD), or similar elements, or a combination of the above elements. The storage media 120 is used for storing the multiple modules or various applications that may be executed by the processor 110. In the embodiment, the storage media 120 may store the multiple modules which include a sample collection module 121, a sample screening module 122, etc., the functions of which will be described later.

The transceiver 130 transmits and receives a signal in a wireless or wired manner. The transceiver 130 may also execute operations such as low noise amplification, impedance matching, frequency mixing, up or down frequency conversion, filtering, amplification, and other similar operations.

The sample collection module 121 may receive N samples corresponding to a first object through the transceiver 130. The N samples may include a first sample and a second sample, where N is the number of the samples and is any positive integer. The N samples may serve as label data which is used to train a model for face recognition. In an embodiment, the N samples may further include a false positive sample of the first object. For example, assuming that the first object is a character A, then the sample collection module 121 may receive N images of the character A through the transceiver 130 to be served as the N samples of the character A. One or more images of a character B (instead of the character A) may exist in the N images. The one or more images of the character B is a false positive sample of the character A. When the N images collected by the sample collection module 121 are used to train a neural network for recognizing the character A, the one or more images of the character B may reduce the efficacy of the neural network in recognizing the character A. In response to this, the disclosure may select a representative image that best represents the character A (or filter out an image least representative of the character A) through screening of the N images by the sample screening module 122. The representative image selected by the sample screening module 122 may serve as the label data. The representative image is used to train the neural network for recognizing the character A, so as to prevent the efficacy of the trained neural network from being reduced by the influence of the false positive sample(s).

The sample screening module 122 may calculate N similarity vectors respectively corresponding to the N samples. The N similarity vectors may include a first similarity vector corresponding to the first sample, a second similarity vector corresponding to the second sample, . . . , a K-th similarity vector corresponding to a K-th sample, . . . , a N-th similarity vector corresponding to a N-th sample, where K is a positive integer less than N. The first similarity vector may include (N−1) first similarities between the first sample and each of the N samples except the first sample. An average value of the (N−1) first similarities may be known as the average value of the first similarities. Deducing by analogy, the K-th similarity vector may include (N−1) K-th similarities between the K-th sample and each of the N samples except the K-th sample. An average value of the (N−1) K-th similarities may be known as the average value of the K-th similarities. A size of each of the N similarity vectors may be (N−1)×1. Then, the sample screening module 122 may determine that the first sample is a representative sample of the first object in response to the average value of the first similarities of the first similarity vector being the maximum value among average values of N similarities respectively corresponding to the N similarity vectors. This is shown in equation (1), where y is the representative sample, s1 is the first sample, sK is the K-th sample, sN is the N-th sample, f(x) is the average value of similarities of the x-th similarity vector corresponding to the x-th sample (1≤x≤N), v_{x,i} is a similarity between the x-th sample and the i-th sample, and v_{x,x} is a self-similarity of the x-th sample.

$$\{ \begin{matrix}y = s 1 , if f ( s 1 ) = max ( ( f ( s 1 ) , … f ( sK ) , … , f ( sN ) ) \\ f ( x ) = ( ( {\sum }_{i = 1}^{N} {v}_{x , i} ) - {v}_{x , x} ) / ( N - 1 )\end{matrix} \qquad ( 1 )$$

In an embodiment, the sample screening module 122 may calculate a similarity matrix of the N samples to obtain the N similarity vectors. The sample screening module 122 may calculate the similarities (that is, elements in each of the N similarity vectors) between the samples according to manners such as an inner product, a Euclidean distance, a Manhattan distance or a Chebyshev distance, but the disclosure is not limited thereto.

FIG. 2 is a schematic diagram of a similarity matrix between N images 200 and average values of similarities corresponding to each of the N images 200 according to an embodiment of the disclosure. The N images 200 are the N samples used to train the neural network for recognizing the character A, and the N images 200 may contain at least one false positive sample of the character A (for example, images 230, 240, 250, or 260 corresponding to the character B). In the embodiment, N may be equal to 9, but the disclosure is not limited thereto. Taking FIG. 2 as an example, the sample screening module 122 may calculate the similarity matrix of the N images 200. Taking an image 210 as an example, the sample screening module 122 may calculate the similarities between the image 210 and each of the N images 200 except the image 210. The similarities may serve as the elements of a column corresponding to the image 210 in the similarity matrix, and the similarities may form a similarity vector corresponding to the image 210. Specifically, the sample screening module 122 may calculate that a similarity between the image 210 and an image 220 is 0.592, a similarity between the image 210 and an image 230 is 0.420, a similarity between the image 210 and an image 240 is 0.483, a similarity between the image 210 and an image 250 is 0.425, a similarity between the image 210 and an image 260 is 0.304, a similarity between the image 210 and an image 270 is 0.660, a similarity between the image 210 and an image 280 is 0.582 and a similarity between the image 210 and an image 290 is 0.574. Then, the sample screening module 122 can calculate an average value (that is, an average value of the elements in the first column of the similarity matrix) of the similarities corresponding to the image 210 according to the similarities between the image 210 and each of the N images 200 except the image 210. As shown in FIG. 2, the average value of the similarities corresponding to the image 210 is 0.505, which is shown in equation (2):

$$\frac{( \begin{matrix}0.592 + 0.420 + 0.483 + 0.425 + 0.304 + \\ 0.660 + 0.582 + 0.574\end{matrix} )}{8} = 0.505 \qquad ( 2 )$$

The sample screening module 122 may further calculate average values of similarities of the image 220, the image 230, the image 240, the image 250, the image 260, the image 270, the image 280, and the image 290 to be 0.495, 0.478, 0.493, 0.507, 0.473, 0.480, 0.534, and 0.518, respectively, based on similar steps.

After calculating the average value of the similarities of each of the N images 200, the sample screening module 122 may select the image 280 with the maximum average value (that is, 0.534) of the similarities from the N images 200 to serve as the representative image of the character A, that is, the average value of the similarities corresponding to the image 280 being the maximum value among the average values of the N similarities respectively corresponding to the N samples. In other words, the image 280 may serve as the training data or the label data used to train the neural network for recognizing the character A.

In an embodiment, the sample screening module 122 may filter out a sample that is not as representative (having a lower similarity with the other samples) or is subjected to more severe noise interference from the N samples. Specifically, the sample screening module 122 may filter out the second sample from the N samples in response to an average value of second similarities corresponding to the second sample being the minimum value among the average values of the N similarities respectively corresponding to the N samples. Taking FIG. 2 as an example, the sample screening module 122 may filter out the image 260 from the N images 200 in response to the average value of the similarities of the image 260 being the minimum value of all the average values of the similarities in FIG. 2.

In an embodiment, the sample screening module 122 may filter out the second sample from the N samples in response to a difference between the average value of the second similarities of the second similarity vector corresponding to the second sample and the average value of the first similarities of the first similarity vector corresponding to the first sample being greater than a threshold. Taking FIG. 2 as an example, assuming that the threshold is 0.04, the sample screening module 122 may filter out the image 240 from the N images 200 in response to a difference (that is: 0.534-0.493=0.041) between the average value of the similarities of the image 240 (that is, 0.493) and the average value of the similarities of the image 280 (that is, 0.534) being greater than the threshold. It is worth noting that the threshold may be adjusted by the user according to actual needs.

In an embodiment, the sample collection module 121 may receive a newly added sample corresponding to the first object through the transceiver 130. The sample screening module 122 may calculate a newly added sample similarity vector corresponding to the newly added sample. The newly added sample similarity vector may include the N similarities between the newly added sample and each of the N samples. The sample screening module 122 may add the newly added sample to the original N samples in response to an average value (as shown in equation (3)) of the similarities of the newly added sample similarity vector being greater than the average value (as shown in equation (4)) of the average values of the N similarities respectively corresponding to the N samples. On the other hand, the sample screening module 122 may delete the newly added sample in response to an average value of the similarities of the newly added sample similarity vector being less than the average value of the average values of the N similarities respectively corresponding to the N samples. That is, the sample screening module 122 may not add the newly added sample to the original N samples. In the equation (3), f(z) is the average value of the similarities corresponding to the newly added sample similarity vector, and v_{z,i} is the similarity between the newly added sample and the i-th sample. In the equation (4), g is the average value of the average values of the N similarities, and f(x) is the average value of the similarities of the x-th similarity vector corresponding to the x-th sample (as shown in the equations (1) and (2)).

$$\begin{matrix}f ( z ) = ( ( {\sum }_{i = 1}^{N} {v}_{z , i} ) ) / N & ( 3 ) \\ g = {\sum }_{i = 1}^{N} f ( x ) / ( N ) & ( 4 )\end{matrix}$$

In this way, the electronic device and the method for screening the sample may provide screening during input of the sample, which can save the amount of data usage by the sample data in the storage media, as well as calculating the quantity of the sample used, while maintaining the accuracy of the sample data.

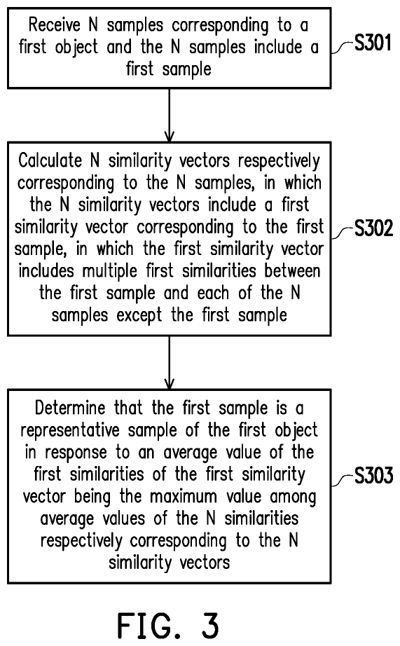

FIG. 3 shows a flowchart of a method for screening a sample according to an embodiment of the disclosure. The method may be implemented by the electronic device 100 shown in FIG. 1. In Step S301, the N samples corresponding to the first object are received. The N samples include the first sample. In Step S302, the N similarity vectors respectively corresponding to the N samples are calculated. The N similarity vectors include the first similarity vector corresponding to the first sample. The first similarity vector includes the multiple first similarities between the first sample and each of the N samples except the first sample. In Step S303, the first sample is determined to be the representative sample of the first object in response to the average value of the first similarities of the first similarity vector being the maximum value among the average values of the N similarities respectively corresponding to the N similarity vectors.

In summary, the disclosure proposes the electronic device and the method for screening the sample, which may calculate the similarities between each of the samples in the multiple samples, so as to select the representative sample that best represents the multiple samples from the multiple samples through the similarities. In addition, the proposed electronic device and the proposed method may also screen the existing sample data or the newly added sample. Compared with using all of the samples to train the neural network, a lot of time and calculation resources can be saved by using only the representative sample to train the neural network. In addition, if there is an erroneous sample (or a sample that is subjected to severe noise interference) in the multiple samples, the disclosure may also filter out the erroneous sample, enabling the efficacy of the trained neural network to not be reduced due to the influence of the erroneous sample.

The foregoing description of the exemplary embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby enabling persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the terms “the invention”, “the present disclosure” or the like does not necessarily limit the claim scope to a specific embodiment, and the reference to particularly exemplary embodiments of the disclosure does not imply a limitation on the disclosure, and no such limitation is to be inferred. The disclosure is limited only by the spirit and scope of the appended claims.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An electronic device for screening a sample, comprising a transceiver, a storage media and a processor, wherein
the storage media stores a plurality of modules; and
the processor is coupled to the storage media and the transceiver, and accesses and executes the plurality of modules, wherein the plurality of modules comprise:
a sample collection module that receives N samples corresponding to a first object through the transceiver, wherein the N samples include a first sample; and
a sample screening module that calculates N similarity vectors respectively corresponding to the N samples, wherein the N similarity vectors comprise a first similarity vector corresponding to the first sample, wherein the first similarity vector comprises a plurality of first similarities between the first sample and each of the N samples except the first sample, wherein the sample screening module determines the first sample to be a representative sample of the first object in response to an average value of the first similarities of the first similarity vector being a maximum value among average values of N similarities respectively corresponding to the N similarity vectors.

2. The electronic device according to claim 1, wherein the sample screening module calculates elements in each of the N similarity vectors according to at least one of:
an inner product, an Euclidean distance, a Manhattan distance, and a Chebyshev distance.

3. The electronic device according to claim 1, wherein the N samples comprise a false positive sample of the first object.

4. The electronic device according to claim 1, wherein the sample screening module calculates a similarity matrix of the N samples to obtain the N similarity vectors.

5. The electronic device according to claim 1, wherein the N samples further comprise a second sample, wherein the N similarity vectors further comprise a second similarity vector corresponding to the second sample, wherein the sample screening module filters out the second sample from the N samples in response to an average value of second similarities of the second similarity vector being a minimum value among the average values of the N similarities.

6. The electronic device according to claim 1, wherein
the sample collection module receives a newly added sample corresponding to the first object through the transceiver, and
the sample screening module calculates a newly added sample similarity vector corresponding to the newly added sample, wherein the newly added sample similarity vector comprises a plurality of similarities between the newly added sample and the each of the N samples, wherein the sample screening module
adds the newly added sample to the N samples in response to an average value of the similarities of the newly added sample similarity vector being greater than an average value of the average values of the N similarities; and
deletes the newly added sample in response to the average value of the similarities of the newly added sample similarity vector being less than the average value of the average values of the N similarities.

7. A method for screening a sample, comprising:
receiving N samples corresponding to a first object, wherein the N samples comprise a first sample;
calculating N similarity vectors respectively corresponding to the N samples, wherein the N similarity vectors comprise a first similarity vector corresponding to the first sample, wherein the first similarity vector comprises a plurality of first similarities between the first sample and each of the N samples except the first sample; and
determining the first sample to be a representative sample of the first object in response to an average value of the first similarities of the first similarity vector being a maximum value among average values of N similarities respectively corresponding to the N similarity vectors.

8. The method according to claim 7, wherein the step of calculating the N similarity vectors respectively corresponding to the N samples comprises calculating elements in each of the N similarity vectors according to at least one of:
an inner product, an Euclidean distance, a Manhattan distance, and a Chebyshev distance.

9. The method according to claim 7, wherein the N samples comprise a false positive sample of the first object.

10. The method according to claim 7, wherein the step of calculating the N similarity vectors respectively corresponding to the N samples comprises:
calculating a similarity matrix of the N samples to obtain the N similarity vectors.

11. The method according to claim 7, wherein the N samples further comprise a second sample, wherein the N similarity vectors further comprise a second similarity vector corresponding to the second sample, wherein the method further comprises:
filtering out the second sample from the N samples in response to an average value of second similarities of the second similarity vector being a minimum value among the average values of the N similarities.

12. The method according to claim 7, further comprising:
receiving a newly added sample corresponding to the first object;
calculating a newly added sample similarity vector corresponding to the newly added sample, wherein the newly added sample similarity vector comprises a plurality of similarities between the newly added sample and the each of the N samples;
adding the newly added sample to the N samples in response to an average value of the similarities of the newly added sample similarity vector being greater than an average value of the average values of the N similarities; and
deleting the newly added sample in response to the average value of the similarities of the newly added sample similarity vector being less than the average value of the average values of the N similarities.
